(19) United States
(12) Patent Application Publication
(10) Pub. No.: US 2026/0319611 A1
(43) Pub. Date: Oct. 15, 2026

(54) TOUCH CONTROL STRUCTURE AND DISPLAY APPARATUS

(71) Applicants: Chengdu BOE Optoelectronics Technology Co., Ltd., Chengdu, Sichuan (CN); BOE Technology Group Co., Ltd., Beijing (CN)

(72) Inventors: Chi Yu, Beijing (CN); Fan He, Beijing (CN); Tong Yang, Beijing (CN); Taofeng Xie, Beijing (CN); Ming Hu, Beijing (CN); Chunyan Li, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 18/839,423

(22) PCT Filed: Nov. 28, 2023
(86) PCT No.: PCT/CN2023/134604

§ 371 Date: Aug. 17, 2024

(51) Int. Cl. G06F 3/041; G06F 3/044

(52) U.S. Cl. CPC G06F 3/04164; G06F 3/04166; G06F 3/0446; G06F 3/0412; G06F 2203/04111

(57) ABSTRACT

A touch control structure is provided. The touch control structure includes a plurality of first touch electrodes, a plurality of second touch electrodes, a plurality of first touch control signal lines, and a plurality of second touch control signal lines. Multiple first touch electrodes of the plurality of first touch electrodes in a first region are connected to multiple first touch control signal lines of the plurality of first touch control signal lines on only a first side of a touch control region of the touch control structure. Multiple first touch electrodes of the plurality of first touch electrodes in a second region are connected to multiple first touch control signal lines of the plurality of first touch control signal lines on a second side of a touch control region of the touch control structure. The first side and the second side are different from each other.

### TECHNICAL FIELD

The present invention relates to display technology, more particularly, to a touch control structure and a display apparatus.

### BACKGROUND

Various types of touch panels have been developed. Examples of touch panels include one-glass-solution (OGS) touch panels, on-cell touch panels, and in-cell touch panels. The on-cell touch panels provide high touch control accuracy. The on-cell touch panels can be classified into single-layer-on-cell (SLOC) touch panels and multi-layer-on-cell (MLOC) touch panels. In particular, multiple point touch control can be achieved in the MLOC touch panels with superior touch control accuracy and blanking effects.

### SUMMARY

In one aspect, the present disclosure provides a touch control structure, comprising a plurality of first touch electrodes, a plurality of second touch electrodes, a plurality of first touch control signal lines, and a plurality of second touch control signal lines; wherein the plurality of first touch control signal lines are connected to the plurality of first touch electrodes, respectively; the plurality of second touch control signal lines are connected to the plurality of second touch electrodes, respectively: multiple first touch electrodes of the plurality of first touch electrodes in a first region are connected to multiple first touch control signal lines of the plurality of first touch control signal lines on only a first side of a touch control region of the touch control structure; multiple first touch electrodes of the plurality of first touch electrodes in a second region are connected to multiple first touch control signal lines of the plurality of first touch control signal lines on a second side of a touch control region of the touch control structure; and the first side and the second side are different from each other: wherein the touch control structure comprises a window region; wherein in a continuous row, all first touch blocks in the continuous row are electrically connected to each other, in a respective non-continuous row of one or more non-continuous rows along the first direction, the window region spaces apart first touch blocks in the respective non-continuous row into a first part and a second part; in a continuous column along a second direction, all second touch blocks in the continuous column are electrically connected to each other; and in a respective non-continuous column of one or more non-continuous columns along the second direction, the window region spaces apart second touch blocks in the respective non-continuous column into a third part and a fourth part; wherein the first region and the second region are non-overlapping regions, and the window region is in the second region.

Optionally, multiple first touch electrodes of the plurality of first touch electrodes in a second region are connected to multiple first touch control signal lines of the plurality of first touch control signal lines on only a second side of a touch control region of the touch control structure.

Optionally, wherein first touch blocks in the first part in the respective non-continuous row are connected to a corresponding first touch control signal line of the plurality of first touch control signal lines, and first touch blocks in the second part in the respective non-continuous row are electrically isolated from the corresponding first touch control signal line of the plurality of first touch control signal lines.

Optionally, one or more first touch blocks in the second part of the respective non-continuous row are electrically connected to first touch blocks in the continuous row; and the one or more first touch blocks in the second part of the respective non-continuous row and the first touch blocks in the continuous row are configured to receive signals from and/or transmit signals to a same first touch control signal line of the plurality of first touch control signal lines.

Optionally, wherein second touch blocks in the third part in the non-continuous column are connected to a corresponding second touch control signal line of the plurality of second touch control signal lines; and second touch blocks in the fourth part in the respective non-continuous column are electrically isolated from the corresponding second touch control signal line of the plurality of second touch control signal lines.

Optionally, one or more second touch blocks in the fourth part of the respective non-continuous column are electrically connected to second touch blocks in the continuous column; and the one or more second touch blocks in the fourth part of the respective non-continuous column and the second touch blocks in the continuous column are configured to receive signals from and/or transmit signals to a same second touch control signal line of the plurality of second touch control signal lines.

Optionally, the touch control structure comprises a corner region; wherein second parts of the one or more non-continuous rows and fourth parts of the one or more non-continuous columns are in the corner region; the touch control structure outside the comer region is configured to detect a touch in a mutual-capacitance touch sensing mode; the touch control structure in the first region is configured to detect a touch in a mutual-capacitance touch sensing mode; and the touch control structure in the second region but outside the corner region is configured to detect a touch in a mutual-capacitance touch sensing mode.

Optionally, the corner region comprises a first self-capacitance touch region, a second self-capacitance touch region, and a mutual-capacitance region; fourth parts of the one or more non-continuous columns are in the first self-capacitance touch region; second parts of the one or more non-continuous rows are in the second self-capacitance touch region; one or more first touch blocks in the mutual-capacitance region are electrically connected to one or more first touch control signal lines of the plurality of first touch control signal lines; and one or more second touch blocks in the mutual-capacitance region are electrically connected to one or more second touch control signal lines of the plurality of second touch control signal lines.

Optionally, the corner region is part of the second region.

Optionally, all first touch blocks in second parts of the one or more non-continuous rows are electrically connected to first touch blocks in the continuous row; all first touch blocks in second parts of the one or more non-continuous rows and the first touch blocks in the continuous row are configured to receive signals from and/or transmit signals to a same first touch control signal line of the plurality of first touch control signal lines; all second touch blocks in fourth parts of the one or more non-continuous columns are electrically connected to second touch blocks in the continuous column; and all second touch blocks in fourth parts of the one or more non-continuous columns and the second touch blocks in the continuous column are configured to receive signals from and/or transmit signals to a same second touch control signal line of the plurality of second touch control signal lines.

Optionally, every other row of first touch blocks in second parts of the one or more non-continuous rows are electrically connected to first touch blocks in the continuous row; every other row of first touch blocks in second parts of the one or more non-continuous rows and the first touch blocks in the continuous row are configured to receive signals from and/or transmit signals to a same first touch control signal line of the plurality of first touch control signal lines; every other column of second touch blocks in fourth parts of the one or more non-continuous columns are electrically connected to second touch blocks in the continuous column; and every other column of second touch blocks in fourth parts of the one or more non-continuous columns and the second touch blocks in the continuous column are configured to receive signals from and/or transmit signals to a same second touch control signal line of the plurality of second touch control signal lines.

Optionally, every other row of first touch blocks in second parts of the one or more non-continuous rows are electrically connected to first touch blocks in the continuous row; every other row of first touch blocks in second parts of the one or more non-continuous rows and the first touch blocks in the continuous row are configured to receive signals from and/or transmit signals to a same first touch control signal line of the plurality of first touch control signal lines; all second touch blocks in fourth parts of the one or more non-continuous columns are electrically connected to second touch blocks in the continuous column; and all second touch blocks in fourth parts of the one or more non-continuous columns and the second touch blocks in the continuous column are configured to receive signals from and/or transmit signals to a same second touch control signal line of the plurality of second touch control signal lines.

Optionally, the touch control structure comprises a corner region; the touch control structure outside the corner region is configured to detect a touch in a mutual-capacitance touch sensing mode; the touch control structure in the first region is configured to detect a touch in a mutual-capacitance touch sensing mode; and the touch control structure in the second region but outside the corner region is configured to detect a touch in a mutual-capacitance touch sensing mode.

Optionally, the touch control structure comprises a corner region; wherein the corner region comprises a first self-capacitance touch region, a second self-capacitance touch region, and a mutual-capacitance region; one or more second touch blocks in the first self-capacitance touch region are electrically isolated from the plurality of second touch control signal lines; one or more first second touch blocks in the first self-capacitance touch region are electrically connected to one or more first touch control signal lines of the plurality of first touch control signal lines; one or more first touch blocks in the second self-capacitance touch region are electrically isolated from the plurality of first touch control signal lines; one or more second touch blocks in the second self-capacitance touch region are electrically connected to one or more second touch control signal lines of the plurality of second touch control signal lines; one or more first touch blocks in the mutual-capacitance region are electrically connected to one or more first touch control signal lines of the plurality of first touch control signal lines; and one or more second touch blocks in the mutual-capacitance region are electrically connected to one or more second touch control signal lines of the plurality of second touch control signal lines.

Optionally, the second region comprising a first subregion and a second subregion; multiple first touch electrodes of the plurality of first touch electrodes in the first subregion are connected to multiple first touch control signal lines of the plurality of first touch control signal lines on only the second side of a touch control region of the touch control structure; and multiple first touch electrodes of the plurality of first touch electrodes in the second subregion are connected to multiple first touch control signal lines of the plurality of first touch control signal lines on the second side of a touch control region of the touch control structure, and connected to a plurality of third touch control signal lines on the first side of the touch control structure.

Optionally, the plurality of second touch electrodes are connected to the plurality of second touch control signal lines on a third side of a touch control region of the touch control structure; multiple second touch electrodes of the plurality of first touch electrodes in a third subregion of the touch control region are connected to multiple second touch control signal lines of the plurality of second touch control signal lines on only the third side of the touch control region of the touch control structure; multiple second touch electrodes of the plurality of first touch electrodes in a fourth subregion of the touch control region are connected to multiple second touch control signal lines of the plurality of second touch control signal lines on the third side of the touch control region of the touch control structure, and connected to a plurality of fourth touch control signal lines on a fourth side of the touch control region of the touch control structure; and the third side and the fourth side are different from each other.

Optionally, the touch control structure comprises a comer region; wherein the touch control structure in the first region is configured to detect a touch in a mutual-capacitance touch sensing mode; the touch control structure in the second region but outside the corner region is configured to detect a touch in a mutual-capacitance touch sensing mode; and the touch control structure in the comer region is configured to detect a touch in a mutual-capacitance touch sensing mode.

Optionally, wherein first touch blocks in the first part in the respective non-continuous row are connected to a corresponding first touch control signal line of the plurality of first touch control signal lines; first touch blocks in the second part in the respective non-continuous row are electrically isolated from the corresponding first touch control signal line of the plurality of first touch control signal lines; and first touch blocks in the second part in the respective non-continuous row are electrically connected to a corresponding third touch control signal line of the plurality of third touch control signal lines.

Optionally, wherein second touch blocks in the third part in the non-continuous column are connected to a corresponding second touch control signal line of the plurality of second touch control signal lines; second touch blocks in the fourth part in the respective non-continuous column are electrically isolated from the corresponding second touch control signal line of the plurality of second touch control signal lines; and second touch blocks in the fourth part in the respective non-continuous column are electrically connected to a corresponding fourth touch control signal line of the plurality of fourth touch control signal lines.

In another aspect, the present disclosure provides a display apparatus, comprising the touch control structure described herein or fabricated by a method described herein, and a display panel.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating a touch control structure in some embodiments according to the present disclosure.

FIG. 2 is a schematic diagram illustrating a touch control structure in some embodiments according to the present disclosure.

FIG. 3 illustrates several exemplary positions for having a window region in a display panel in some embodiments according to the present disclosure.

FIG. 4 is a schematic diagram illustrating a touch control structure in some embodiments according to the present disclosure.

FIG. 5A illustrates a plurality of first touch electrodes in the touch control structure depicted in FIG. 4.

FIG. 5B illustrates a plurality of second touch electrodes in the touch control structure depicted in FIG. 4.

FIG. 5C illustrates one or more self-capacitance touch regions and one or more mutual-capacitance regions in the touch control structure depicted in FIG. 4.

FIG. 6 is a schematic diagram illustrating a touch control structure in some embodiments according to the present disclosure.

FIG. 7A illustrates a plurality of first touch electrodes in the touch control structure depicted in FIG. 6.

FIG. 7B illustrates a plurality of second touch electrodes in the touch control structure depicted in FIG. 6.

FIG. 7C illustrates multiple first touch electrodes in a corner region in the touch control structure depicted in FIG. 6.

FIG. 7D illustrates multiple second touch electrodes in a corner region in the touch control structure depicted in FIG. 6.

FIG. 7E illustrates a plurality of first touch electrodes in a touch control structure in some embodiments according to the present disclosure.

FIG. 7F illustrates a plurality of second touch electrodes in a touch control structure in some embodiments according to the present disclosure.

FIG. 8 is a schematic diagram illustrating a touch control structure in some embodiments according to the present disclosure.

FIG. 9A illustrates a plurality of first touch electrodes in the touch control structure depicted in FIG. 8.

FIG. 9B illustrates a plurality of second touch electrodes in the touch control structure depicted in FIG. 8.

FIG. 9C illustrates multiple first touch electrodes in a comer region in the touch control structure depicted in FIG. 8.

FIG. 9D illustrates multiple second touch electrodes in a corner region in the touch control structure depicted in FIG. 8.

FIG. 10 illustrates a plurality of first touch electrodes in a touch control structure in some embodiments according to the present disclosure.

FIG. 11 illustrates a plurality of second touch electrodes in a touch control structure in some embodiments according to the present disclosure.

FIG. 12 is a schematic diagram illustrating a touch control structure in some embodiments according to the present disclosure.

FIG. 13 illustrates one or more self-capacitance touch regions and one or more mutual-capacitance regions in the touch control structure depicted in FIG. 12.

FIG. 14 is a schematic diagram illustrating a touch control structure in some embodiments according to the present disclosure.

FIG. 15 is a schematic diagram illustrating a touch control structure in some embodiments according to the present disclosure.

FIG. 16 is a schematic diagram illustrating a touch control structure in some embodiments according to the present disclosure.

FIG. 17 is a schematic diagram illustrating a touch control structure in some embodiments according to the present disclosure.

FIG. 18A illustrates a detailed structure in a display area in a display apparatus in some embodiments according to the present disclosure.

FIG. 18B illustrates a detailed structure in a display area in a display apparatus in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only, It is not intended to be exhaustive or to be limited to the precise form disclosed.

The present disclosure provides, inter alia, a touch control structure and a display apparatus that substantially obviate one or more of the problems due to limitations and disadvantages of the related art. In one aspect, the present disclosure provides a touch control structure. In some embodiments, the touch control structure includes a plurality of first touch electrodes, a plurality of second touch electrodes, a plurality of first touch control signal lines, and a plurality of second touch control signal lines. Optionally, the plurality of first touch control signal lines are connected to the plurality of first touch electrodes, respectively. Optionally, the plurality of second touch control signal lines are connected to the plurality of second touch electrodes, respectively. Optionally, multiple first touch electrodes of the plurality of first touch electrodes in a first region are connected to multiple first touch control signal lines of the plurality of first touch control signal lines on only a first side of a touch control region of the touch control structure. Optionally, multiple first touch electrodes of the plurality of first touch electrodes in a second region are connected to multiple first touch control signal lines of the plurality of first touch control signal lines on a second side of a touch control region of the touch control structure. Optionally, the first side and the second side are different from each other.

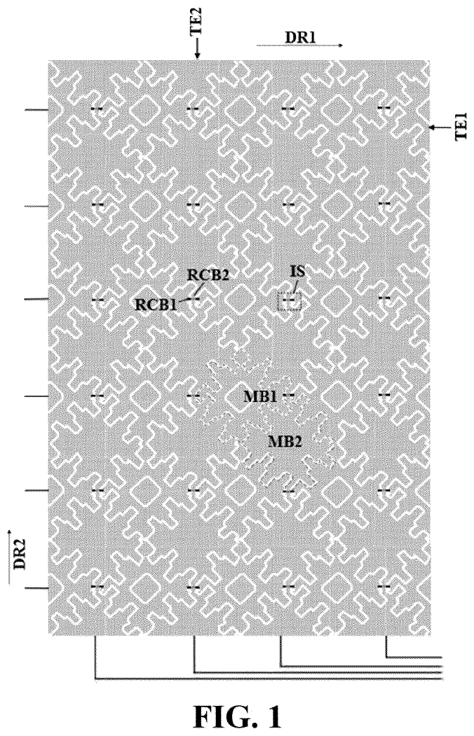

FIG. 1 is a schematic diagram illustrating a touch control structure in some embodiments according to the present disclosure. Referring to FIG. 1, the touch control structure in some embodiments includes a plurality of first touch electrodes TE1 arranged in a plurality of rows and a plurality of second touch electrodes TE2 arranged in a plurality of columns. In one example, the plurality of first touch electrodes TE1 are a plurality of first mesh electrodes, and the plurality of second touch electrodes TE2 are a plurality of second mesh electrodes. The plurality of first touch electrodes TE1 are arranged in a plurality of rows, each of the plurality of rows is a respective one of the plurality of first touch electrodes TE1. The plurality of second touch electrodes TE2 arranged in a plurality of columns, each of the plurality of columns is a respective one of the plurality of second touch electrodes TE2. Optionally, the touch control structure is a mutual capacitance type touch control structure, Optionally, the plurality of first touch electrodes TE1 are a plurality of touch sensing electrodes, and the plurality of second touch electrodes TE2 are a plurality of touch scanning electrodes. Optionally, the plurality of first touch electrodes TE1 are a plurality of touch scanning electrodes, and the plurality of second touch electrodes TE2 are a plurality of touch sensing electrodes.

As shown in FIG. 1, a respective one of the plurality of first touch electrodes TE1 includes a plurality of first touch blocks MB1 consecutively electrically connected in a respective row along a first direction DR1, a respective one of the plurality of second touch electrodes TE2 includes a plurality of second touch blocks MB2 consecutively electrically connected in a respective column along a second direction DR2. In one example, the plurality of first touch blocks MB1 are a plurality of first mesh blocks, and the plurality of second touch blocks MB2 are a plurality of second mesh blocks. In FIG. 1, a respective one of the plurality of first touch blocks MB1 and a respective one of the plurality of second touch blocks MB2 are depicted as blocks respectively encircled by dotted lines.

In some embodiments, two adjacent first touch blocks of the plurality of first touch blocks MB1 are electrically connected to each other through a respective first conductive bridge RCB1 of a plurality of first conductive bridges. The plurality of first conductive bridges are located in a plurality of intersections. A respective intersection IS of the plurality of intersections is where two adjacent first touch blocks of the plurality of first touch blocks MB1 of a respective one of the plurality of first touch electrodes TE1 electrically connect to each other, and where two adjacent second touch blocks of the plurality of second touch blocks MB2 of a respective one of the plurality of second touch electrodes TE2 electrically connect to each other.

In some embodiments, the plurality of first conductive bridges are in a first touch line layer; while the plurality of first touch blocks MB1 and the plurality of second touch blocks MB2 are in a second touch line layer.

In some embodiments, two adjacent second touch blocks of the plurality of second touch blocks MB2 are electrically connected to each other through a respective second conductive bridge RCB2 of a plurality of second conductive bridges. Optionally, the plurality of first conductive bridges are in a first touch line layer; while the plurality of first touch blocks MB1, the plurality of second touch blocks MB2, and the plurality of second conductive bridges are in a second touch line layer. The respective first conductive bridge RCB1 cross over the respective second conductive bridge RCB2.

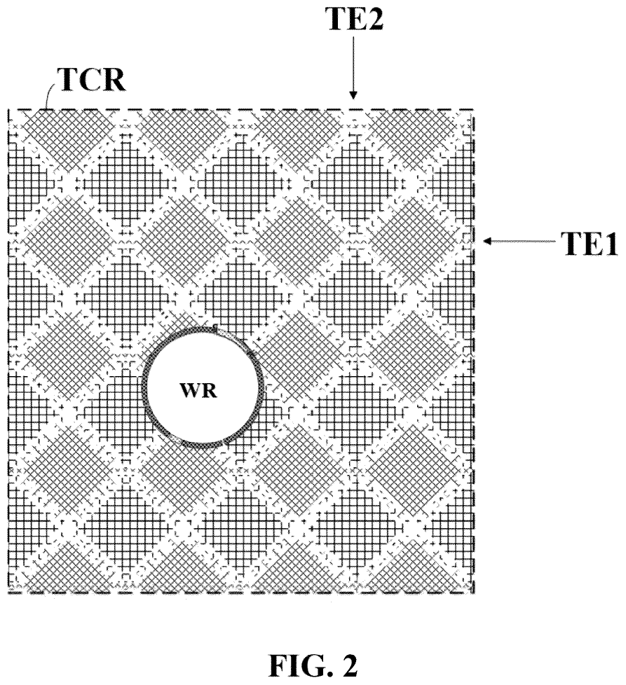

FIG. 2 is a schematic diagram illustrating a touch control structure in some embodiments according to the present disclosure, Referring to FIG. 2, the touch control structure in some embodiments includes a plurality of first touch electrodes TE1 and a plurality of second touch electrodes TE2. Optionally, the touch control structure is a mutual capacitance type touch control structure. Optionally, the plurality of first touch electrodes TE1 are a plurality of touch scanning electrodes, and the plurality of second touch electrodes TE2 are a plurality of touch sensing electrodes. Optionally, the plurality of first touch electrodes TE1 are a plurality of touch sensing electrodes, and the plurality of second touch electrodes TE2 are a plurality of touch scanning electrodes. The touch control structure is limited in a touch control region TCR and absent in a window region WR surrounded by the touch control region TCR. For example, the touch control structure may be a touch control structure in a display panel, where the touch control region TCR substantially overlaps with a display region of the display panel, and the window region WR is a region in the display panel having a hole configured for installing an accessory such as a camera lens or a fingerprint sensor. The display panel is configured to display an image in at least a portion of the touch control region TCR. In one example, in the window region WR, display elements of the display panel and the touch control structure are absent; in the display region or at least a portion of the touch control region TCR, both display elements of the display panel and the touch control structure are present.

Referring to FIG. 2, in some embodiments, the plurality of first touch electrodes TE1 are arranged in a plurality of rows, each of which is a respective one of the plurality of touch electrodes TE1; the plurality of second touch electrodes TE2 are arranged in a plurality of columns, each of which is a respective one of the plurality of second touch electrodes TE2

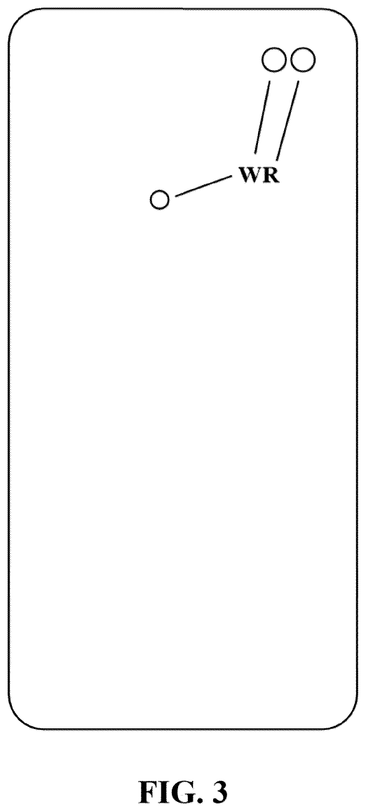

FIG. 3 illustrates several exemplary positions for having a window region in a display panel in some embodiments according to the present disclosure. The display panel may have a hole configured for installing an accessory such as a camera lens or a fingerprint sensor in the window region WR. In some embodiments, the hole is a blind hole that does not completely extends through at least one layer of the display panel. In some embodiments, the hole is a through-hole that completely extends through the display panel.

In some embodiments, the touch display panel includes a touch control structure. Flexible multi-layer on-cell touch (FMLOC) technology is utilized to form mesh electrode pattern on top of an encapsulating layer of the touch display panel. The mesh electrode pattern includes touch scanning electrodes and touch sensing electrodes, and optionally fill patterns (“dummy patterns”). A touch detection integrated circuit is configured to detect a touch by sensing a mutual capacitance between a touch scanning electrode and a touch sensing electrode, and a change of the mutual capacitance upon a touch.

In some embodiments, an electronic device such as a display panel having the touch control structure includes a metallic ring structure around the edge of the window region WR. The inventors of the present disclosure discover that, due to the presence of the metal ring, it is difficult to have conductive lines (e.g., conductive bridges) around the window region WR configured to connect touch blocks on two sides (e.g., two opposite sides) of the window region WR. Moreover, a number of channels of the touch detection integrated circuit is limited, and a number of touch detection integrated circuits that can be disposed in the electronic device is limited due to space limitation. The inventors of the present disclosure discover that the touch control structure according to the present disclosure can, surprisingly and unexpectedly, enable sufficient touch control in regions surrounding the window region WR.

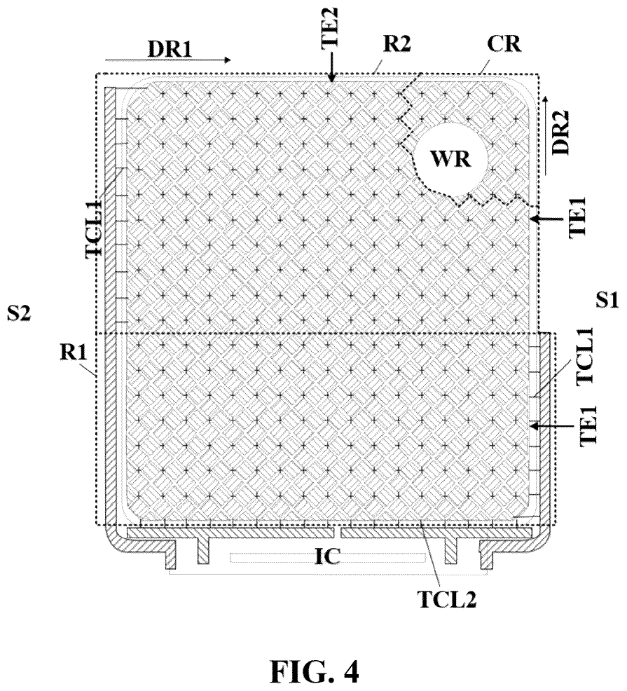

FIG. 4 is a schematic diagram illustrating a touch control structure in some embodiments according to the present disclosure. Referring to FIG. 4, the touch control structure in some embodiments includes a first region R1 and a second region R2. In some embodiments, the touch control structure includes a plurality of first touch electrodes TE1 and a plurality of second touch electrodes TE2. A respective first touch electrode of the plurality of first touch electrodes TE1 extends along a first direction DR1. A respective second touch electrode of the plurality of second touch electrodes TE2 extends along a second direction DR2. The touch control structure in some embodiments further includes a plurality of first touch control signal lines TCL1 and a plurality of second touch control signal lines TCL2. The plurality of first touch control signal lines TCL1 are connected to the plurality of first touch electrodes TE1, respectively. The plurality of second touch control signal lines TCL2 are connected to the plurality of second touch electrodes TE2, respectively.

In some embodiments, multiple first touch electrodes of the plurality of first touch electrodes TE1 in the first region R1 are connected to multiple first touch control signal lines of the plurality of first touch control signal lines TCL1 on only a first side S1 of a touch control region of the touch control structure; multiple first touch electrodes of the plurality of first touch electrodes TE1 in the second region R2 are connected to multiple first touch control signal lines of the plurality of first touch control signal lines TCL1 on only a second side S2 of a touch control region of the touch control structure; the first side S1 and the second side S2 are different from each other. Optionally, the first side S1 and the second side S2 are opposite to each other.

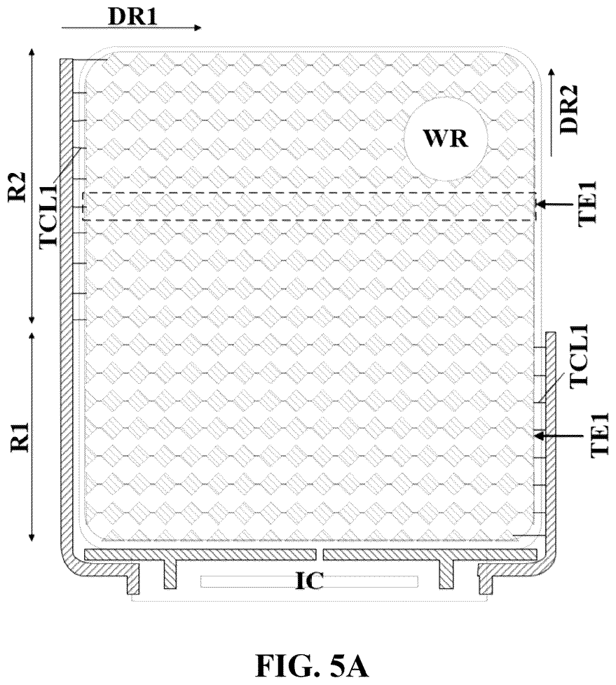

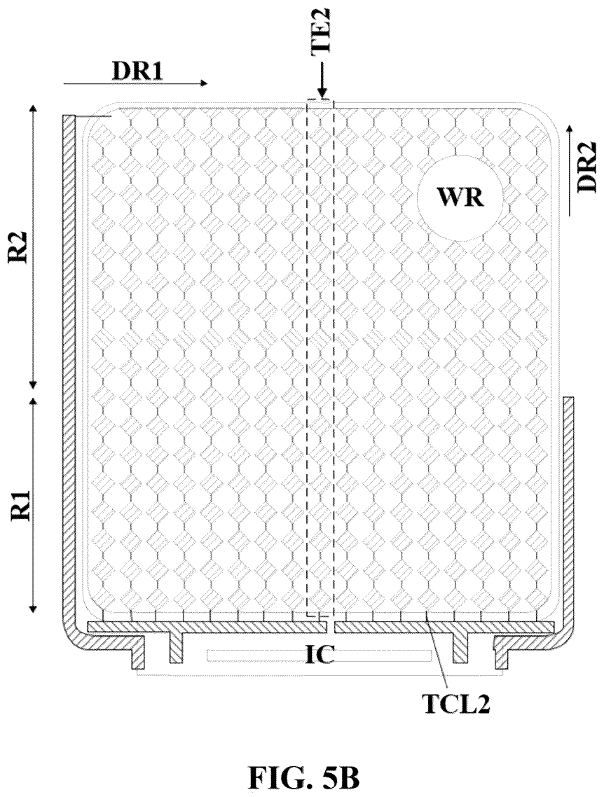

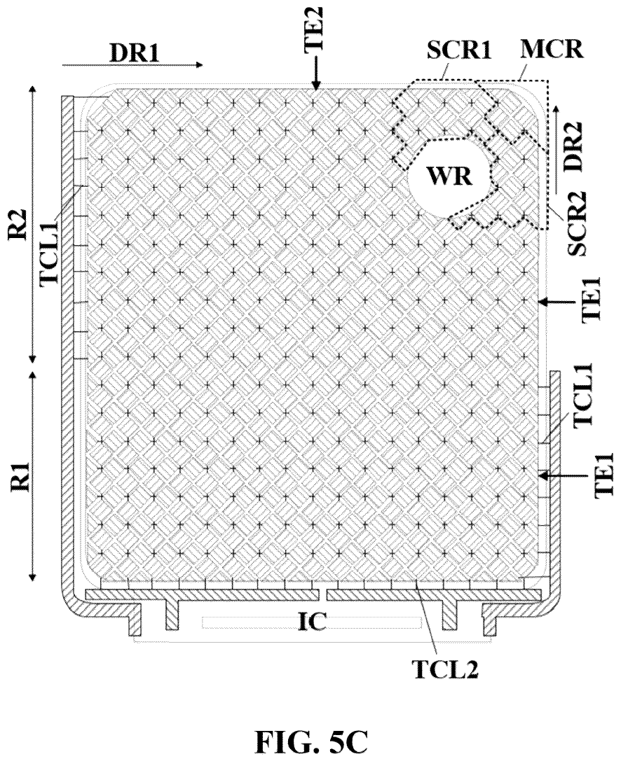

FIG. 5A illustrates a plurality of first touch electrodes in the touch control structure depicted in FIG. 4. FIG. 5B illustrates a plurality of second touch electrodes in the touch control structure depicted in FIG. 4. FIG. 5C illustrates one or more self-capacitance touch regions and one or more mutual-capacitance regions in the touch control structure depicted in FIG. 4. Referring to FIG. 4, and FIG. 5A to FIG. 5C, the touch control structure in some embodiments includes a corner region CR. In some embodiments, the corner region CR is part of the second region R2.

In some embodiments, the touch control structure outside the corner region CR is configured to detect a touch in a mutual-capacitance touch sensing mode. In some embodiments, the touch control structure in the first region R1 is configured to detect a touch in a mutual-capacitance touch sensing mode. In some embodiments, the touch control structure in the second region R2 but outside the comer region CR is configured to detect a touch in a mutual-capacitance touch sensing mode.

In some embodiments, the corner region CR includes one or more self-capacitance touch regions and one or more mutual-capacitance regions, Optionally, the comer region CR includes a first self-capacitance touch region SCR1, a second self-capacitance touch region SCR2, and a mutual-capacitance region MCR. One or more second touch blocks in the first self-capacitance touch region SCR1 are electrically isolated from the plurality of second touch control signal lines TCL2; one or more first second touch blocks in the first self-capacitance touch region SCR1 are electrically connected to one or more first touch control signal lines of the plurality of first touch control signal lines TCL1. One or more first touch blocks in the second self-capacitance touch region SCR2 are electrically isolated from the plurality of first touch control signal lines TCL1; one or more second touch blocks in the second self-capacitance touch region SCR2 are electrically connected to one or more second touch control signal lines of the plurality of second touch control signal lines TCL2. One or more first touch blocks in the mutual-capacitance region MCR are electrically connected to one or more first touch control signal lines of the plurality of first touch control signal lines TCL1; one or more second touch blocks in the mutual-capacitance region MCR are electrically connected to one or more second touch control signal lines of the plurality of second touch control signal lines TCL2.

The inventors of the present disclosure discover that the touch control structure according to the present disclosure can, surprisingly and unexpectedly, enable sufficient touch control in regions surrounding the window region WR without increasing the number of channels of the touch detection integrated circuit or the number of touch detection integrated circuits.

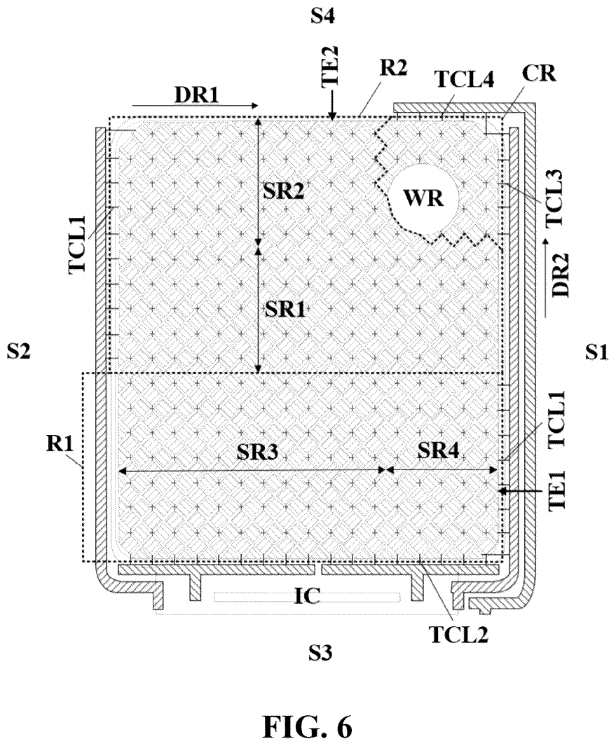

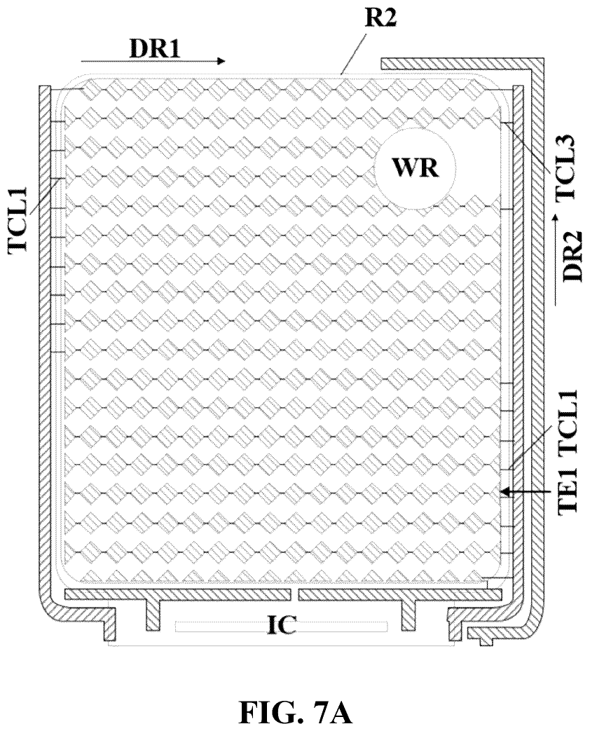

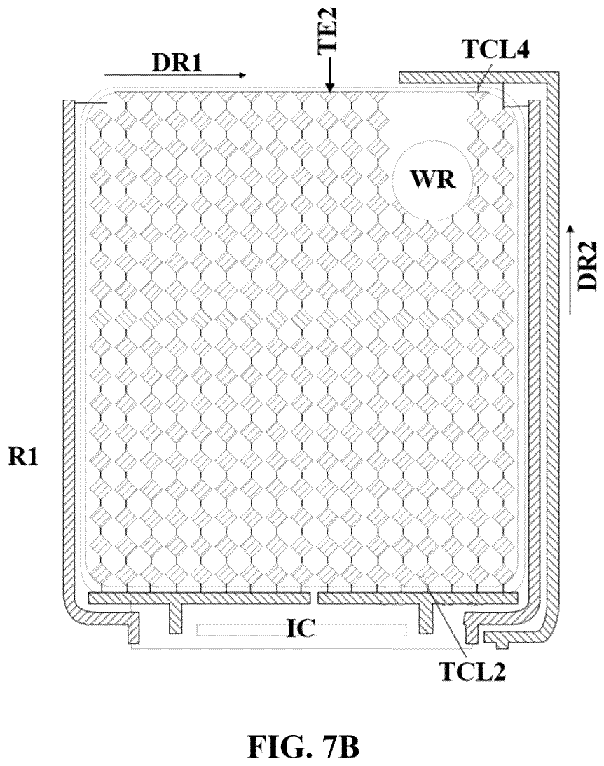

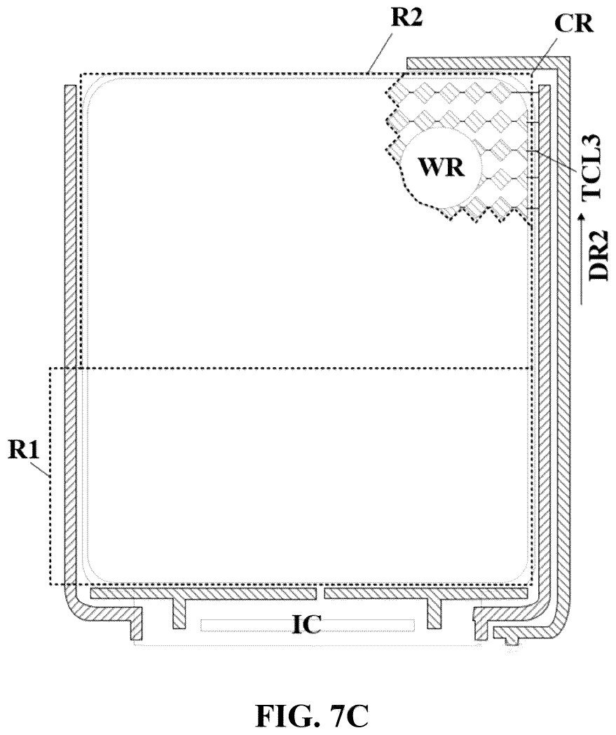

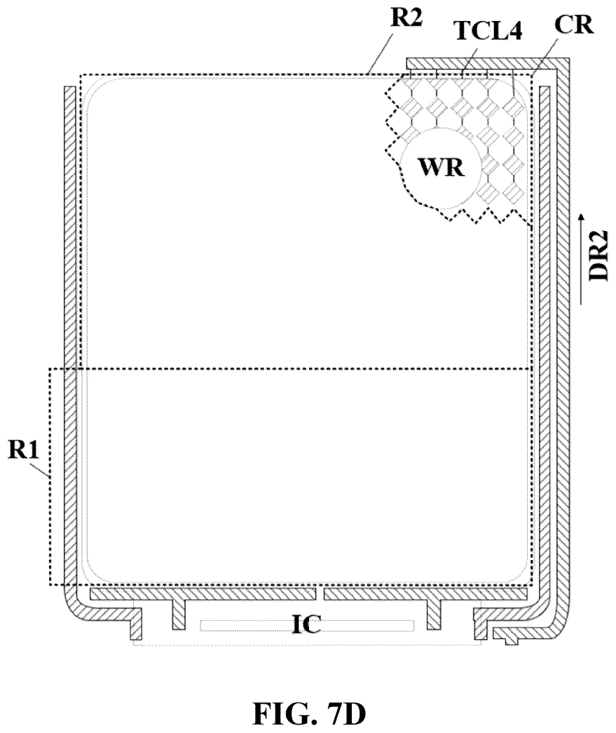

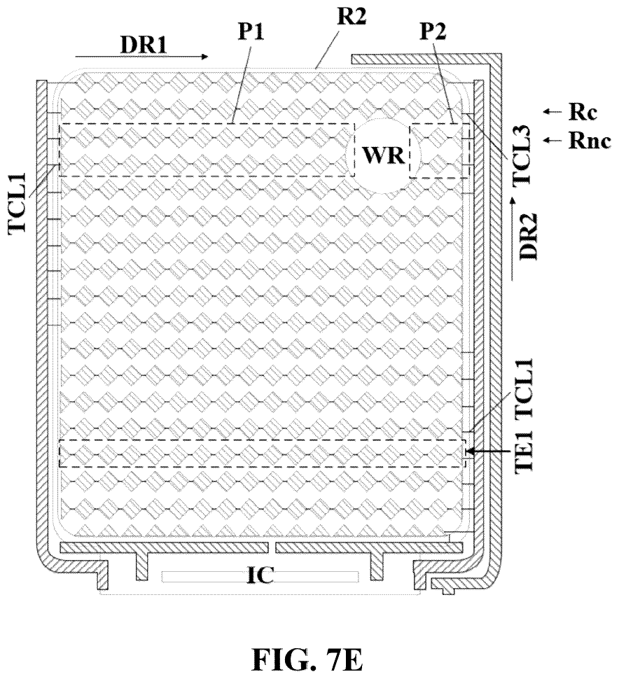

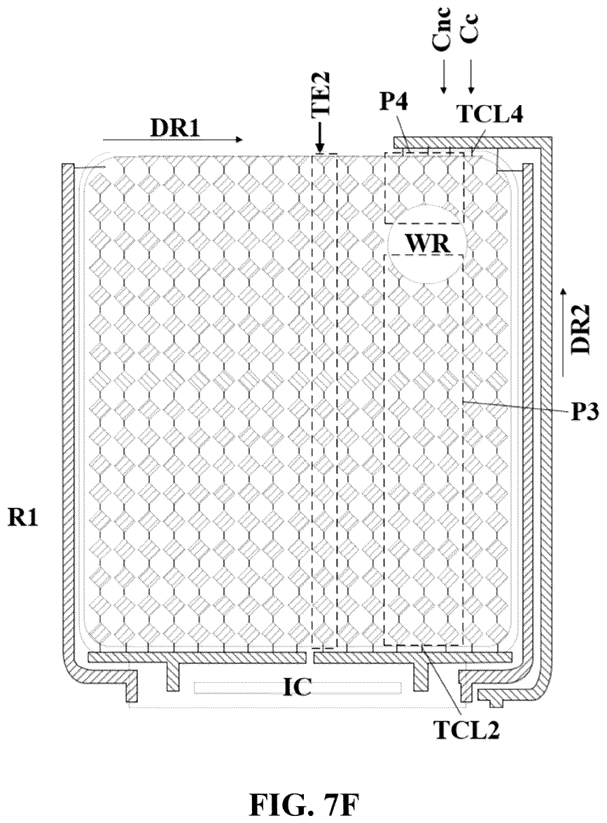

FIG. 6 is a schematic diagram illustrating a touch control structure in some embodiments according to the present disclosure, FIG. 7A illustrates a plurality of first touch electrodes in the touch control structure depicted in FIG. 6. FIG. 7B illustrates a plurality of second touch electrodes in the touch control structure depicted in FIG. 6. FIG. 7C illustrates multiple first touch electrodes in a corner region in the touch control structure depicted in FIG. 6. FIG. 7D illustrates multiple second touch electrodes in a corner region in the touch control structure depicted in FIG. 6. FIG. 7E illustrates a plurality of first touch electrodes in a touch control structure in some embodiments according to the present disclosure. FIG. 7F illustrates a plurality of second touch electrodes in a touch control structure in some embodiments according to the present disclosure.

Referring to FIG. 6, and FIG. 7A to FIG. 7D, the touch control structure in some embodiments includes a first region R1 and a second region R2. In some embodiments, the touch control structure includes a plurality of first touch electrodes TE1 and a plurality of second touch electrodes TE2. A respective first touch electrode of the plurality of first touch electrodes TE1 extends along a first direction DR1. A respective second touch electrode of the plurality of second touch electrodes TE2 extends along a second direction DR2. The touch control structure in some embodiments further includes a plurality of first touch control signal lines TCL1 and a plurality of second touch control signal lines TCL2. The plurality of first touch control signal lines TCL1 are connected to the plurality of first touch electrodes TE1, respectively. The plurality of second touch control signal lines TCL2 are connected to the plurality of second touch electrodes TE2, respectively.

In some embodiments, multiple first touch electrodes of the plurality of first touch electrodes TE1 in the first region R1 are connected to multiple first touch control signal lines of the plurality of first touch control signal lines TCL1 on only a first side S1 of a touch control region of the touch control structure. In some embodiments, multiple first touch electrodes of the plurality of first touch electrodes TE1 in the second region R2 are connected to multiple first touch control signal lines of the plurality of first touch control signal lines TCL1 on a second side S2 of a touch control region of the touch control structure; the first side S1 and the second side S2 are different from each other. Optionally, the first side S1 and the second side S2 are opposite to each other. In some embodiments, multiple first touch electrodes of the plurality of first touch electrodes TE1 in a first subregion SR1 of the second region R2 are connected to multiple first touch control signal lines of the plurality of first touch control signal lines TCL1 on only the second side S2 of a touch control region of the touch control structure. In some embodiments, multiple first touch electrodes of the plurality of first touch electrodes TE1 in a second subregion SR2 of the second region R2 are connected to multiple first touch control signal lines of the plurality of first touch control signal lines TCL1 on the second side S2 of a touch control region of the touch control structure, and connected to a plurality of third touch control signal lines TCL3 on the first side S1 of the touch control structure.

In some embodiments, the plurality of second touch electrodes TE2 are connected to the plurality of second touch control signal lines TCL2 on a third side S3 of a touch control region of the touch control structure. In some embodiments, multiple second touch electrodes of the plurality of first touch electrodes TE1 in a third subregion SR3 of the touch control region are connected to multiple second touch control signal lines of the plurality of second touch control signal lines TCL2 on only the third side S3 of the touch control region of the touch control structure. In some embodiments, multiple second touch electrodes of the plurality of first touch electrodes TE1 in a fourth subregion SR4 of the touch control region are connected to multiple second touch control signal lines of the plurality of second touch control signal lines TCL2 on the third side S3 of the touch control region of the touch control structure, and connected to a plurality of fourth touch control signal lines TCL4 on a fourth side S4 of the touch control region of the touch control structure; the third side S3 and the fourth side S4 are different from each other. Optionally, the third side S3 and the fourth side S4 are opposite to each other.

In some embodiments, the touch control structure includes a corner region CR. In some embodiments, the corner region CR is part of the second region R2. In some embodiments, the corner region CR is part of the second subregion SR2 of the second region R2.

In some embodiments, the touch control structure is configured to detect a touch in a mutual-capacitance touch sensing mode. In some embodiments, the touch control structure in the first region R1 is configured to detect a touch in a mutual-capacitance touch sensing mode. In some embodiments, the touch control structure in the second region R2 but outside the corner region CR is configured to detect a touch in a mutual-capacitance touch sensing mode, In some embodiments, the touch control structure in the second region R2 but outside the corner region CR is configured to detect a touch in a mutual-capacitance touch sensing mode. Optionally, the touch control structure is configured to detect a touch in a mutual-capacitance touch sensing mode in substantially (e.g., at least 70%, at least 80%, at least 90%, at least 95%. at least 99%, or 100%) an entire area of the touch control region.

The inventors of the present disclosure discover that the touch control structure according to the present disclosure can, surprisingly and unexpectedly, enable sufficient touch control in regions surrounding the window region WR without increasing the number of channels of the touch detection integrated circuit or the number of touch detection integrated circuits.

FIG. 7E illustrates a plurality of first touch electrodes in a touch control structure in some embodiments according to the present disclosure. Referring to FIG. 7E, in some embodiments, in a continuous row Rc along a first direction DR1, all first touch blocks in the continuous row Rc are electrically connected to each other. In some embodiments, in a respective non-continuous row of one or more non-continuous rows Rnc along the first direction DR1, the window region WR spaces apart first touch blocks in the respective non-continuous row into a first part P1 and a second part P2. First touch blocks in the first part P1 in the respective non-continuous row are connected to a corresponding first touch control signal line of the plurality of first touch control signal lines TCL1. First touch blocks in the second part P2 in the respective non-continuous row are electrically isolated from the corresponding first touch control signal line of the plurality of first touch control signal lines TCL1. First touch blocks in the second part P2 in the respective non-continuous row are electrically connected to a corresponding third touch control signal line of the plurality of third touch control signal lines TCL3.

FIG. 7F illustrates a plurality of second touch electrodes in a touch control structure in some embodiments according to the present disclosure, Referring to FIG. 7P, in some embodiments, in a continuous column Cc along a second direction DR2, all second touch blocks in the continuous column Cc are electrically connected to each other. In some embodiments, in a respective non-continuous column of one or more non-continuous columns Cnc along the second direction DR2, the window region WR spaces apart second touch blocks in the respective non-continuous column into a third part P3 and a fourth part P4. Second touch blocks in the third part P3 in the non-continuous column Cc are connected to a corresponding second touch control signal line of the plurality of second touch control signal lines TCL2. Second touch blocks in the fourth part P4 in the respective non-continuous column are electrically isolated from the corresponding second touch control signal line of the plurality of second touch control signal lines TCL2. Second touch blocks in the fourth part P4 in the respective non-continuous column are electrically connected to a corresponding fourth touch control signal line of the plurality of fourth touch control signal lines TCL4.

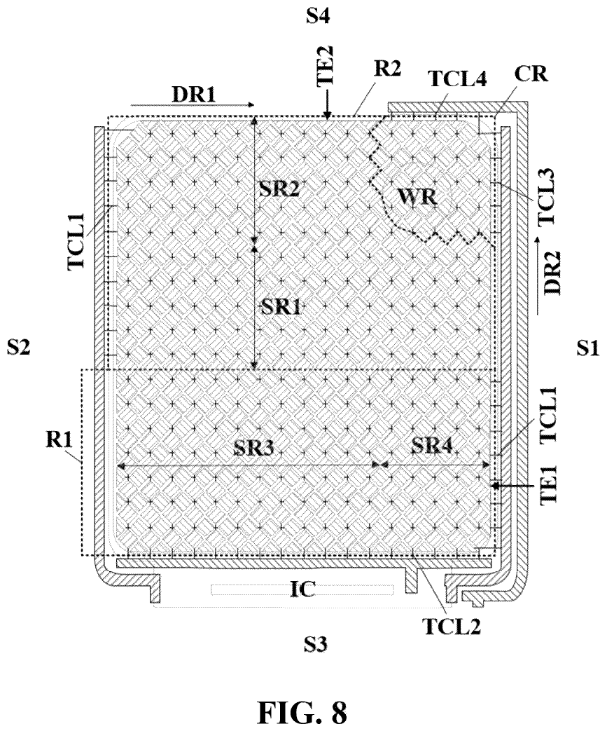

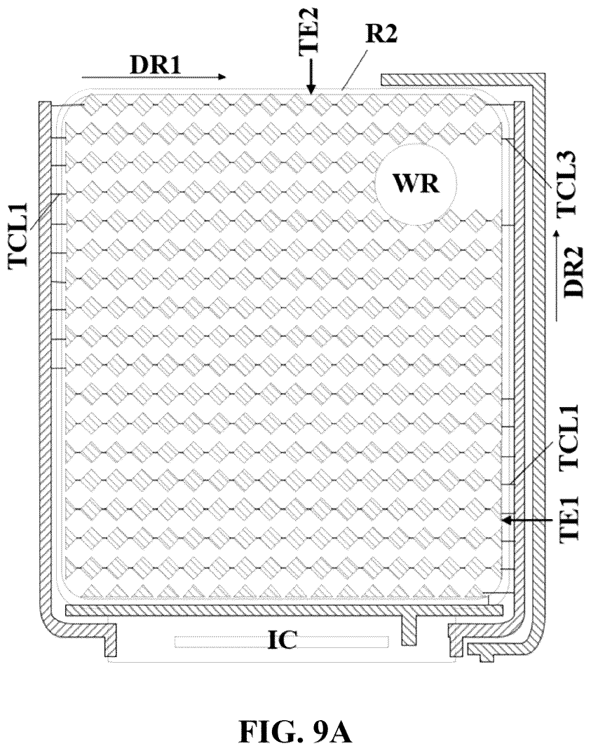

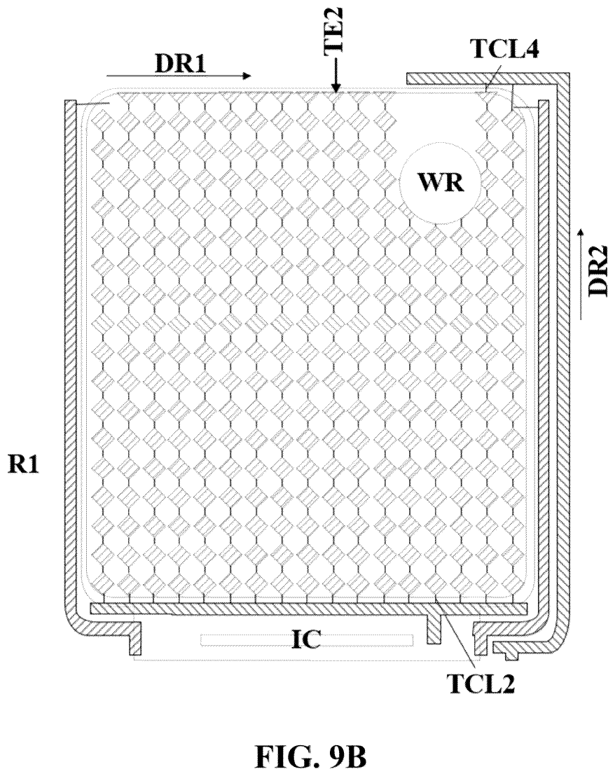

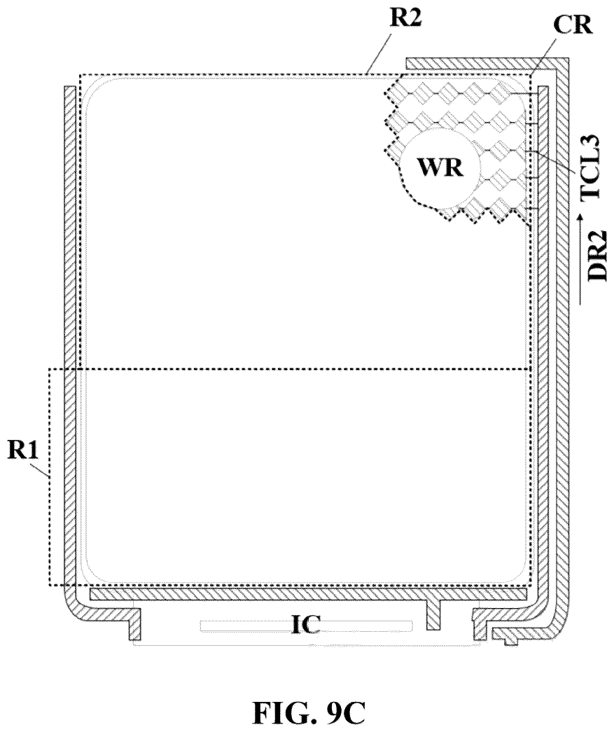

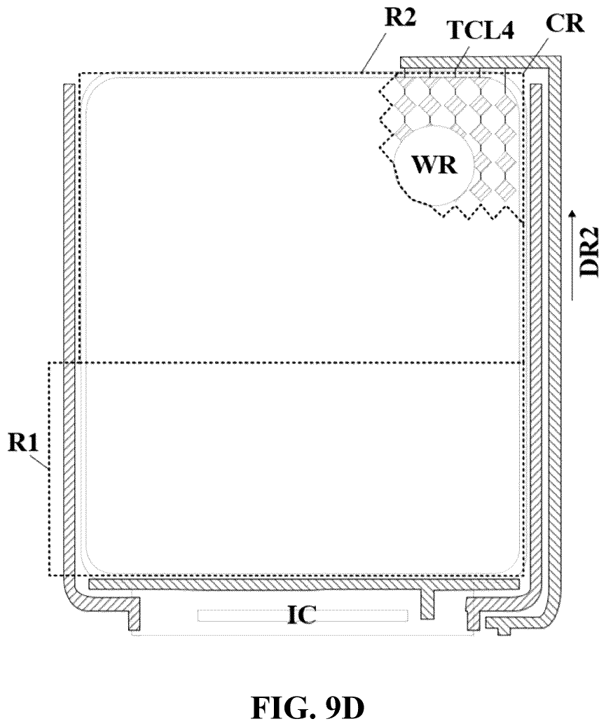

FIG. 8 is a schematic diagram illustrating a touch control structure in some embodiments according to the present disclosure. FIG. 9A illustrates a plurality of first touch electrodes in the touch control structure depicted in FIG. 8. FIG. 9B illustrates a plurality of second touch electrodes in the touch control structure depicted in FIG. 8. FIG. 9C illustrates multiple first touch electrodes in a corner region in the touch control structure depicted in FIG. 8. FIG. 9D illustrates multiple second touch electrodes in a corner region in the touch control structure depicted in FIG. 8. The touch control structure depicted in FIG. 8, and FIG. 9A to FIG. 9D differs from the touch control structure depicted in FIG. 6, and FIG. 7A to FIG. 7D in that, in the touch control structure depicted in FIG. 6, and FIG. 7A to FIG. 7D, multiple second touch control signal lines of the plurality of second touch control signal lines TCL2 are connected to multiple first pins, multiple second touch control signal lines of the plurality of second touch control signal lines TCL2 are connected to multiple second pins, the multiple first pins and the multiple second pins are spaced apart from each other. In one example, the multiple first pins are spaced apart from the multiple second pins by an integrated circuit IC. Whereas, in the touch control structure depicted in FIG. 8, and FIG. 9A to FIG. 9D, the plurality of second touch control signal lines TCL2 are connected to pins clustered on a same side relative to the integrated circuit IC.

The inventors of the present disclosure discover that the touch control structure according to the present disclosure can, surprisingly and unexpectedly, enable sufficient touch control in regions surrounding the window region WR without increasing the number of channels of the touch detection integrated circuit or the number of touch detection integrated circuits.

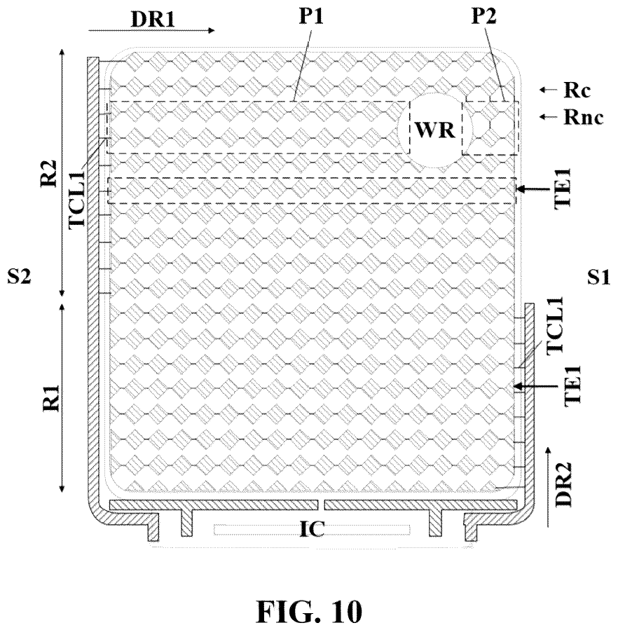

FIG. 10 illustrates a plurality of first touch electrodes in a touch control structure in some embodiments according to the present disclosure. Referring to FIG. 10, in some embodiments, in a continuous row Re along a first direction DR1, all first touch blocks in the continuous row Rc are electrically connected to each other. In some embodiments, in a respective non-continuous row of one or more non-continuous rows Rnc along the first direction DR1, the window region WR spaces apart first touch blocks in the respective non-continuous row into a first part P1 and a second part P2. First touch blocks in the first part P1 in the respective non-continuous row are connected to a corresponding first touch control signal line of the plurality of first touch control signal lines TCL1. First touch blocks in the second part P2 in the respective non-continuous row are electrically isolated from the corresponding first touch control signal line of the plurality of first touch control signal lines TCL1.

In some embodiments, one or more first touch blocks in the second part P2 of the respective non-continuous row are electrically connected to first touch blocks in the continuous row Rc. Optionally, the continuous row Re is adjacent to the one or more non-continuous rows Rnc. In some embodiments, the one or more first touch blocks in the second part P2 of the respective non-continuous row and the first touch blocks in the continuous row Rc are configured to receive signals from and/or transmit signals to a same first touch control signal line of the plurality of first touch control signal lines TCL1.

In some embodiments, one or more first touch blocks in second parts of the one or more non-continuous rows Rnc are electrically connected to first touch blocks in the continuous row Rc. Optionally, the continuous row Rc is adjacent to the one or more non-continuous rows Rnc. In some embodiments, the one or more first touch blocks in second parts of the one or more non-continuous rows Rnc and the first touch blocks in the continuous row Rc are configured to receive signals from and/or transmit signals to a same first touch control signal line of the plurality of first touch control signal lines TCL1.

The inventors of the present disclosure discover that the touch control structure according to the present disclosure can, surprisingly and unexpectedly, enable sufficient touch control in regions surrounding the window region WR without increasing the number of channels of the touch detection integrated circuit or the number of touch detection integrated circuits.

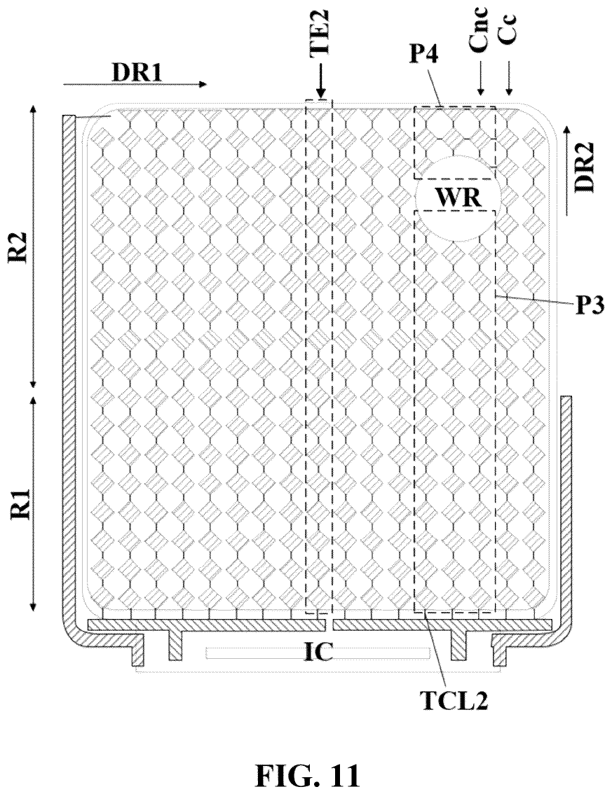

FIG. 11 illustrates a plurality of second touch electrodes in a touch control structure in some embodiments according to the present disclosure. Referring to FIG. 11, in some embodiments, in a continuous column Cc along a second direction DR2, all second touch blocks in the continuous column Cc are electrically connected to each other. In some embodiments, in a respective non-continuous column of one or more non-continuous columns Cnc along the second direction DR2, the window region WR spaces apart second touch blocks in the respective non-continuous column into a third part P3 and a fourth part P4. Second touch blocks in the third part P3 in the non-continuous column Cc are connected to a corresponding second touch control signal line of the plurality of second touch control signal lines TCL2. Second touch blocks in the fourth part P4 in the respective non-continuous column are electrically isolated from the corresponding second touch control signal line of the plurality of second touch control signal lines TCL2.

In some embodiments, one or more second touch blocks in the fourth part P4 of the respective non-continuous column are electrically connected to second touch blocks in the continuous column Cc. Optionally, the continuous column Cc is adjacent to the one or more non-continuous columns Cnc. In some embodiments, the one or more second touch blocks in the fourth part P4 of the respective non-continuous column and the second touch blocks in the continuous column Ce are configured to receive signals from and/or transmit signals to a same second touch control signal line of the plurality of second touch control signal lines TCL2.

In some embodiments, one or more second touch blocks in fourth parts of the one or more non-continuous columns Cnc are electrically connected to second touch blocks in the continuous column Cc. Optionally, the continuous column Cc is adjacent to the one or more non-continuous columns Cnc. In some embodiments, the one or more second touch blocks in fourth parts of the one or more non-continuous columns Cnc and the second touch blocks in the continuous column Cc are configured to receive signals from and/or transmit signals to a same second touch control signal line of the plurality of second touch control signal lines TCL2.

The inventors of the present disclosure discover that the touch control structure according to the present disclosure can, surprisingly and unexpectedly, enable sufficient touch control in regions surrounding the window region WR without increasing the number of channels of the touch detection integrated circuit or the number of touch detection integrated circuits.

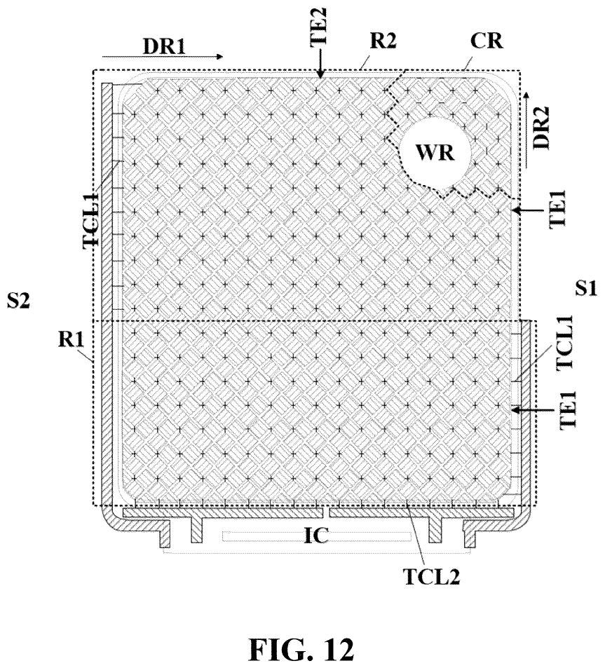

FIG. 12 is a schematic diagram illustrating a touch control structure in some embodiments according to the present disclosure. In one example, FIG. 10 illustrates a plurality of first touch electrodes in the touch control structure depicted in FIG. 12, and FIG. 11 illustrates a plurality of second touch electrodes in the touch control structure depicted in FIG. 12. Referring to FIG. 10 to FIG. 12, the touch control structure in some embodiments includes a first region R1 and a second region R2. In some embodiments, the touch control structure includes a plurality of first touch electrodes TE1 and a plurality of second touch electrodes TE2. A respective first touch electrode of the plurality of first touch electrodes TE1 extends along a first direction DR1. A respective second touch electrode of the plurality of second touch electrodes TE2 extends along a second direction DR2. The touch control structure in some embodiments further includes a plurality of first touch control signal lines TCL1 and a plurality of second touch control signal lines TCL2. The plurality of first touch control signal lines TCL1 are connected to the plurality of first touch electrodes TE1, respectively. The plurality of second touch control signal lines TCL2 are connected to the plurality of second touch electrodes TE2, respectively.

In some embodiments, multiple first touch electrodes of the plurality of first touch electrodes TE1 in the first region R1 are connected to multiple first touch control signal lines of the plurality of first touch control signal lines TCL1 on only a first side S1 of a touch control region of the touch control structure; multiple first touch electrodes of the plurality of first touch electrodes TE1 in the second region R2 are connected to multiple first touch control signal lines of the plurality of first touch control signal lines TCL1 on only a second side S2 of a touch control region of the touch control structure; the first side S1 and the second side S2 are different from each other. Optionally, the first side S1 and the second side S2 are opposite to each other.

In some embodiments, the touch control structure includes a corner region CR. In some embodiments, the corner region CR is part of the second region R2. In some embodiments, second parts of the one or more non-continuous rows Rnc and fourth parts of the one or more non-continuous columns Cnc are in the corner region CR.

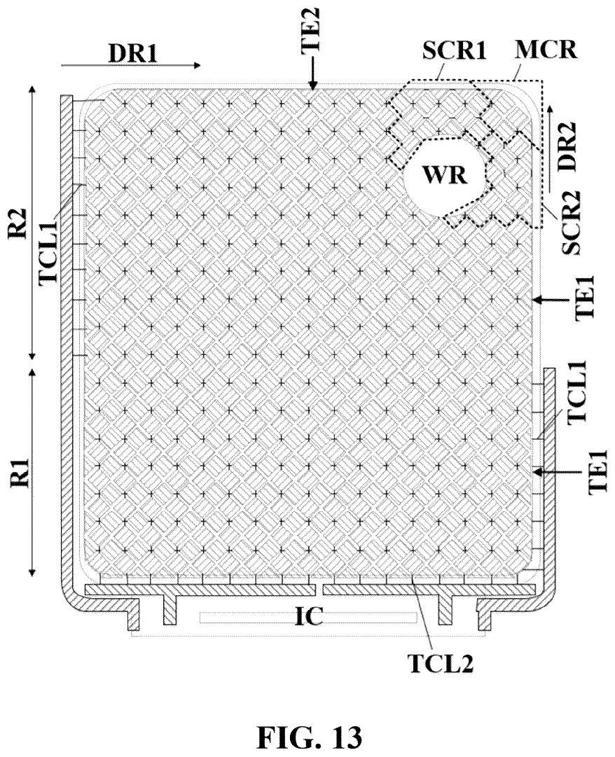

FIG. 13 illustrates one or more self-capacitance touch regions and one or more mutual-capacitance regions in the touch control structure depicted in FIG. 12. In some embodiments, the touch control structure outside the corner region CR is configured to detect a touch in a mutual-capacitance touch sensing mode. In some embodiments, the touch control structure in the first region R1 is configured to detect a touch in a mutual-capacitance touch sensing mode. In some embodiments, the touch control structure in the second region R2 but outside the corner region CR is configured to detect a touch in a mutual-capacitance touch sensing mode.

In some embodiments, the corner region CR includes one or more self-capacitance touch regions and one or more mutual-capacitance regions. Optionally, the comer region CR includes a first self-capacitance touch region SCR1, a second self-capacitance touch region SCR2, and a mutual-capacitance region MCR. In some embodiments, fourth parts of the one or more non-continuous columns Cnc are in the first self-capacitance touch region SCR1. In some embodiments, second parts of the one or more non-continuous rows Rnc are in the second self-capacitance touch region SCR2, One or more first touch blocks in the mutual-capacitance region MCR are electrically connected to one or more first touch control signal lines of the plurality of first touch control signal lines TCL1; one or more second touch blocks in the mutual-capacitance region MCR are electrically connected to one or more second touch control signal lines of the plurality of second touch control signal lines TCL2.

The inventors of the present disclosure discover that the touch control structure according to the present disclosure can, surprisingly and unexpectedly, enable sufficient touch control in regions surrounding the window region WR without increasing the number of channels of the touch detection integrated circuit or the number of touch detection integrated circuits.

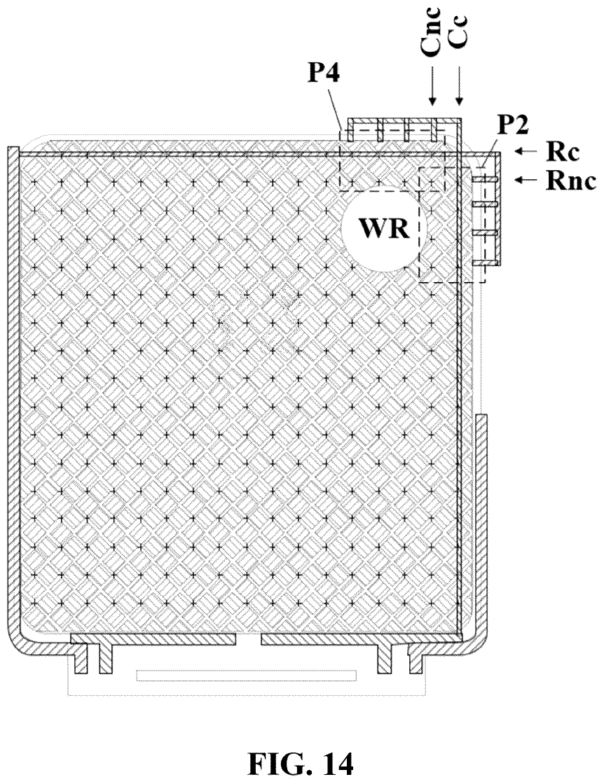

FIG. 14 is a schematic diagram illustrating a touch control structure in some embodiments according to the present disclosure. Referring to FIG. 14, in some embodiments, all first touch blocks in the second part P2 of the respective non-continuous row are electrically connected to first touch blocks in the continuous row Rc. Optionally, the continuous row Re is adjacent to the one or more non-continuous rows Rnc. In some embodiments, all first touch blocks in the second part P2 of the respective non-continuous row and the first touch blocks in the continuous row Rc are configured to receive signals from and/or transmit signals to a same first touch control signal line of the plurality of first touch control signal lines TCL1.

In some embodiments, all first touch blocks in second parts of the one or more non-continuous rows Rnc are electrically connected to first touch blocks in the continuous row Rc. Optionally, the continuous row Re is adjacent to the one or more non-continuous rows Rnc. In some embodiments, all first touch blocks in second parts of the one or more non-continuous rows Rnc and the first touch blocks in the continuous row Rc are configured to receive signals from and/or transmit signals to a same first touch control signal line of the plurality of first touch control signal lines TCL1.

In some embodiments, all second touch blocks in the fourth part P4 of the respective non-continuous column are electrically connected to second touch blocks in the continuous column Cc. Optionally, the continuous column Ce is adjacent to the one or more non-continuous columns Cnc. In some embodiments, all second touch blocks in the fourth part P4 of the respective non-continuous column and the second touch blocks in the continuous column Cc are configured to receive signals from and/or transmit signals to a same second touch control signal line of the plurality of second touch control signal lines TCL2.

In some embodiments, all second touch blocks in fourth parts of the one or more non-continuous columns Cnc are electrically connected to second touch blocks in the continuous column Cc. Optionally, the continuous column Cc is adjacent to the one or more non-continuous columns Cnc. In some embodiments, all second touch blocks in fourth parts of the one or more non-continuous columns Cnc and the second touch blocks in the continuous column Ce are configured to receive signals from and/or transmit signals to a same second touch control signal line of the plurality of second touch control signal lines TCL2.

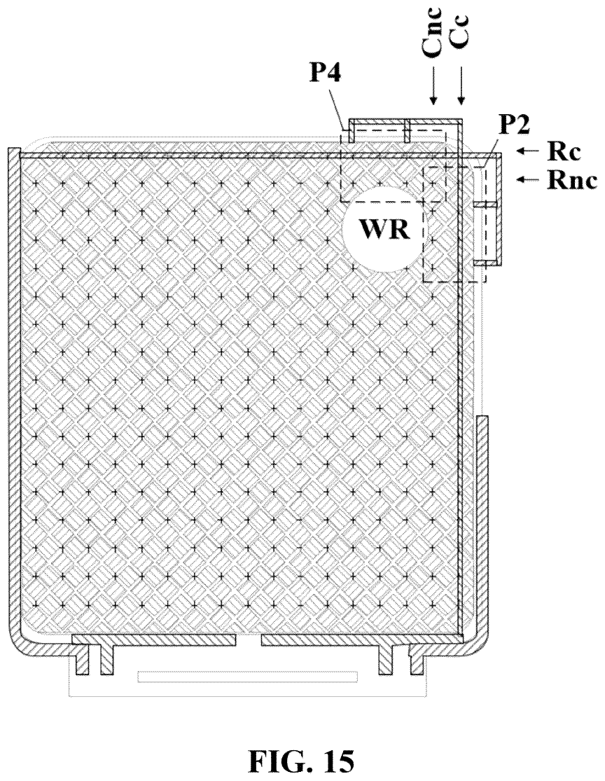

FIG. 15 is a schematic diagram illustrating a touch control structure in some embodiments according to the present disclosure, Referring to FIG. 15, in some embodiments, every other row of first touch blocks in second parts of the one or more non-continuous rows Rnc are electrically connected to first touch blocks in the continuous row Rc. Optionally, the continuous row Rc is adjacent to the one or more non-continuous rows Rnc. In some embodiments, every other row of first touch blocks in second parts of the one or more non-continuous rows Rnc and the first touch blocks in the continuous row Rc are configured to receive signals from and/or transmit signals to a same first touch control signal line of the plurality of first touch control signal lines TCL1.

In some embodiments, every other column of second touch blocks in fourth parts of the one or more non-continuous columns Cnc are electrically connected to second touch blocks in the continuous column Cc. Optionally, the continuous column Cc is adjacent to the one or more non-continuous columns Cnc. In some embodiments, every other column of second touch blocks in fourth parts of the one or more non-continuous columns Cnc and the second touch blocks in the continuous column Cc are configured to receive signals from and/or transmit signals to a same second touch control signal line of the plurality of second touch control signal lines TCL2.

The inventors of the present disclosure discover that the touch control structure according to FIG. 15 can effectively prevent overly high capacitance in the corner region.

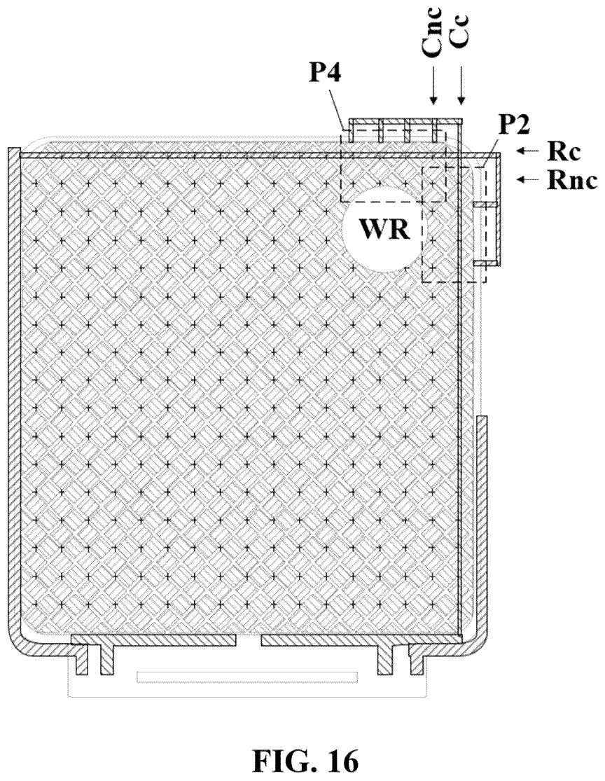

FIG. 16 is a schematic diagram illustrating a touch control structure in some embodiments according to the present disclosure, Referring to FIG. 16, in some embodiments, every other row of first touch blocks in second parts of the one or more non-continuous rows Rnc are electrically connected to first touch blocks in the continuous row Rc. Optionally, the continuous row Rc is adjacent to the one or more non-continuous rows Rnc. In some embodiments, every other row of first touch blocks in second parts of the one or more non-continuous rows Rnc and the first touch blocks in the continuous row Re are configured to receive signals from and/or transmit signals to a same first touch control signal line of the plurality of first touch control signal lines TCL1.

In some embodiments, all second touch blocks in fourth parts of the one or more non-continuous columns Cnc are electrically connected to second touch blocks in the continuous column Cc. Optionally, the continuous column Cc is adjacent to the one or more non-continuous columns Cnc. In some embodiments, all second touch blocks in fourth parts of the one or more non-continuous columns Cnc and the second touch blocks in the continuous column Cc are configured to receive signals from and/or transmit signals to a same second touch control signal line of the plurality of second touch control signal lines TCL2.

The inventors of the present disclosure discover that the touch control structure according to FIG. 16, by having a differentiated design, can effectively achieve better touch detection, For example, when a finger slides from an area having the second part P2 to an area having the fourth part P4, the capacitance detected increases as the finger moves. When a finger slides from an area having the fourth part P4 to an area having the second part P2, the capacitance detected decreases as the finger moves. The two different touch motions may correspond to two different touch inputs.

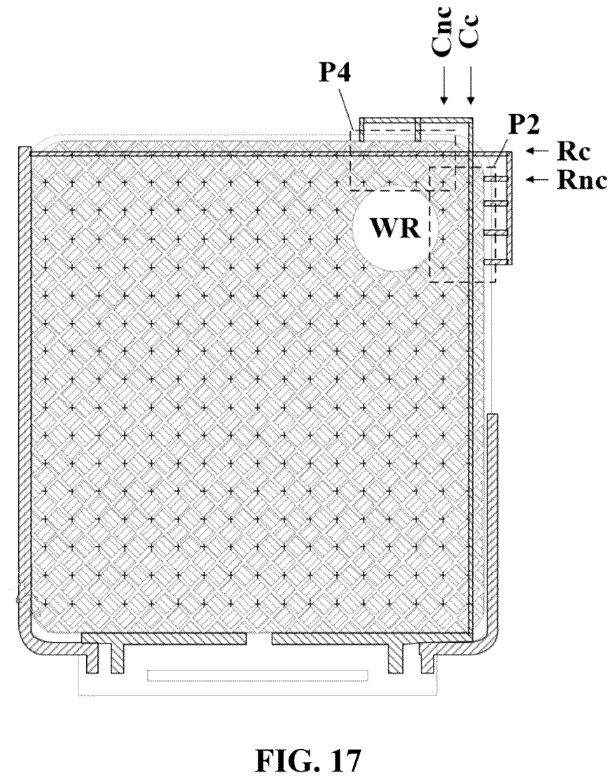

FIG. 17 is a schematic diagram illustrating a touch control structure in some embodiments according to the present disclosure, Referring to FIG. 17, all first touch blocks in second parts of the one or more non-continuous rows Rnc are electrically connected to first touch blocks in the continuous row Rc. Optionally, the continuous row Rc is adjacent to the one or more non-continuous rows Rnc. In some embodiments, all first touch blocks in second parts of the one or more non-continuous rows Rnc and the first touch blocks in the continuous row Rc are configured to receive signals from and/or transmit signals to a same first touch control signal line of the plurality of first touch control signal lines TCL1.

In some embodiments, every other column of second touch blocks in fourth parts of the one or more non-continuous columns Cnc are electrically connected to second touch blocks in the continuous column Cc. Optionally, the continuous column Cc is adjacent to the one or more non-continuous columns Cnc. In some embodiments, every other column of second touch blocks in fourth parts of the one or more non-continuous columns Cnc and the second touch blocks in the continuous column Co are configured to receive signals from and/or transmit signals to a same second touch control signal line of the plurality of second touch control signal lines TCL2.

Various alternative implementations may be practiced according to the present disclosure. In some embodiments, not all first touch blocks in second parts of the one or more non-continuous rows Rnc are electrically connected to first touch blocks in the continuous row Rc. In some embodiment, randomly selected rows of first touch blocks in second parts of the one or more non-continuous rows Rnc are electrically connected to first touch blocks in the continuous row Rc. Optionally, the continuous row Rc is adjacent to the one or more non-continuous rows Rnc.

In some embodiments, not second touch blocks in fourth parts of the one or more non-continuous columns Cnc are electrically connected to second touch blocks in the continuous column Cc. In some embodiment, randomly selected columns of second touch blocks in fourth parts of the one or more non-continuous columns Cnc are electrically connected to second touch blocks in the continuous column Cc. Optionally, the continuous column Cc is adjacent to the one or more non-continuous columns Cnc.

In another aspect, the present disclosure provides a display panel including the touch control structure described herein or fabricated by a method described herein, and a hole in the window region. The display panel is configured to display an image in at least a portion of the touch control region. In some embodiments, display elements of the display panel are absent in the window region.

In another aspect, the present disclosure provides a display apparatus including a display panel described herein or fabricated by a method described herein, and one or more integrated circuits connected to the display panel. Examples of appropriate display apparatuses include, but are not limited to, an electronic paper, a mobile phone, a tablet computer, a television, a monitor, a notebook computer, a digital album, a GPS, etc. Optionally, the display apparatus is an organic light emitting diode display apparatus. Optionally, the display apparatus is a liquid crystal display apparatus.

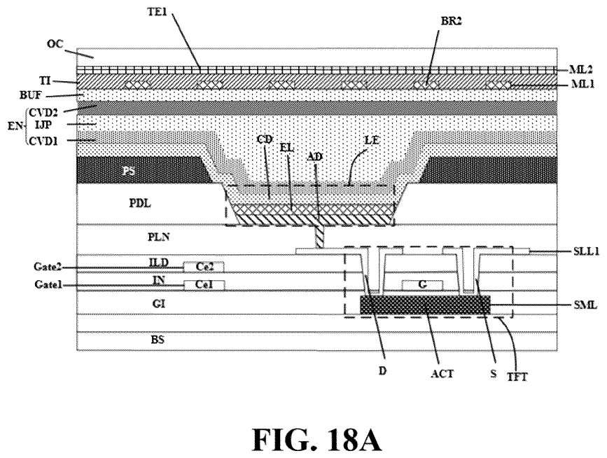

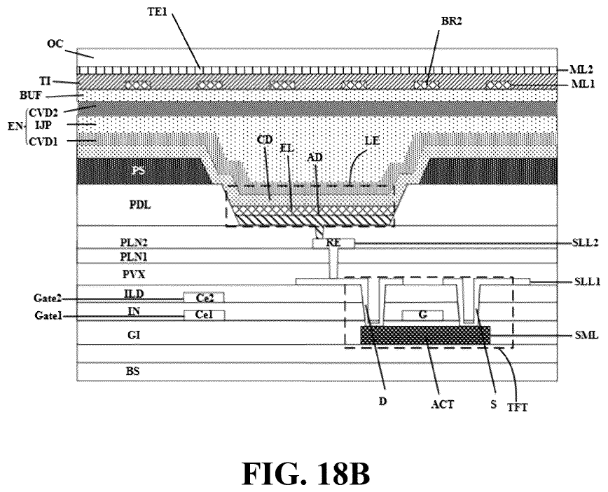

FIG. 18A illustrates a detailed structure in a display area in a display apparatus in some embodiments according to the present disclosure. Referring to FIG. 18A, the display apparatus in the display area in some embodiments includes a base substrate BS (e.g., a flexible base substrate); an active layer ACT of a respective one of a plurality of thin film transistors TFT on the base substrate BS; a gate insulating layer GI on a side of the active layer ACT away from the base substrate BS; a gate electrode G and a first capacitor electrode Ce1 (both are parts of a first gate metal layer) on a side of the gate insulating layer GI away from the base substrate BS; an insulating layer IN on a side of the gate electrode G and the first capacitor electrode Ce1 away from the gate insulating layer GI; a second capacitor electrode Ce2 (a part of a second gate metal layer) on a side of the insulating layer IN away from the gate insulating layer GI; an inter-layer dielectric layer ILD on a side of the second capacitor electrode Ce2 away from the gate insulating layer GI; a source electrode S and a drain electrode D (parts of a first SD metal layer) on a side of the inter-layer dielectric layer ILD away from the gate insulating layer GI; a planarization layer PLN on a side of the source electrode S and the drain electrode D away from the inter-layer dielectric layer ILD; a pixel definition layer PDL defining a subpixel aperture and on a side of the planarization layer PLN away from the base substrate BS; and a light emitting element LE in the subpixel aperture. The light emitting element LE includes an anode AD on a side of the planarization layer PLN away from the inter-layer dielectric layer ILD; a light emitting layer EL on a side of the anode AD away from the planarization layer PLN; and a cathode layer CD on a side of the light emitting layer EL away from the anode AD. The display apparatus in the display area further includes an encapsulating layer EN encapsulating the dummy light emitting element DLE, and on a side of the cathode layer CD away from the base substrate BS. The encapsulating layer EN in some embodiments includes a first inorganic encapsulating sub-layer CVD1 on a side of the cathode layer CD away from the base substrate BS, an organic encapsulating sub-layer IJP on a side of the first inorganic encapsulating sub-layer CVD1 away from the base substrate BS, and a second inorganic encapsulating sub-layer CVD2 on a side of the organic encapsulating sub-layer IJP away from the first inorganic encapsulating sub-layer CVD1. The display apparatus in the display area further includes a buffer layer BUF on a side of the encapsulating layer EN away from the base substrate BS; a plurality of second electrode bridges BR2 on a side of the buffer layer BUF away from the encapsulating layer EN; a touch insulating layer T1 on a side of the plurality of second electrode bridges BR2 away from the buffer layer BUF; a plurality of first touch electrodes TE1 on a side of the touch insulating layer T1 away from the buffer layer BUF; and an overcoat layer OC on a side of the plurality of first touch electrodes TE1 away from the touch insulating layer T1.

FIG. 18B illustrates a detailed structure in a display area in a display apparatus in some embodiments according to the present disclosure. Referring to FIG. 18B, the display apparatus in the display area in some embodiments includes a base substrate BS (e.g., a flexible base substrate); an active layer ACT of a respective one of a plurality of thin film transistors TFT on the base substrate BS; a gate insulating layer GI on a side of the active layer ACT away from the base substrate BS; a gate electrode G and a first capacitor electrode Ce1 (both are parts of a first gate metal layer) on a side of the gate insulating layer GI away from the base substrate BS; an insulating layer IN on a side of the gate electrode G and the first capacitor electrode Ce1 away from the gate insulating layer GI; a second capacitor electrode Ce2 (a part of a second gate metal layer) on a side of the insulating layer IN away from the gate insulating layer GI; an inter-layer dielectric layer ILD on a side of the second capacitor electrode Ce2 away from the gate insulating layer GI; a source electrode S and a drain electrode D (parts of a first SD metal layer) on a side of the inter-layer dielectric layer ILD away from the gate insulating layer GI; a passivation layer PVX on a side of the source electrode S and the drain electrode D away from the inter-layer dielectric layer ILD; a first planarization layer PLN1 on a side of the passivation layer PVX away from the inter-layer dielectric layer ILD; a relay electrode RE (part of a second SD metal layer) on side of the first planarization layer PLN1 away from the passivation layer PVX; a second planarization layer PLN2 on a side of the relay electrode RE away from the first planarization layer PLN1; a pixel definition layer PDL defining a subpixel aperture and on a side of the second planarization layer PLN2 away from the base substrate BS; and a light emitting element LE in the subpixel aperture. The light emitting element LE includes an anode AD on a side of the second planarization layer PLN2 away from the first planarization layer PLN1; a light emitting layer EL on a side of the anode AD away from the second planarization layer PLN2; and a cathode layer CD on a side of the light emitting layer EL away from the anode AD. The display apparatus in the display area further includes an encapsulating layer EN encapsulating the dummy light emitting element DLE, and on a side of the cathode layer CD away from the base substrate BS. The encapsulating layer EN in some embodiments includes a first inorganic encapsulating sub-layer CVD1 on a side of the cathode layer CD away from the base substrate BS, an organic encapsulating sub-layer IJP on a side of the first inorganic encapsulating sub-layer CVD1 away from the base substrate BS, and a second inorganic encapsulating sub-layer CVD2 on a side of the organic encapsulating sub-layer IJP away from the first inorganic encapsulating sub-layer CVD1. The display apparatus in the display area further includes a buffer layer BUF on a side of the encapsulating layer EN away from the base substrate BS; a plurality of second electrode bridges BR2 on a side of the buffer layer BUF away from the encapsulating layer EN; a touch insulating layer T1 on a side of the plurality of second electrode bridges BR2 away from the buffer layer BUF; a plurality of first touch electrodes TE1 on a side of the touch insulating layer T1 away from the buffer layer BUF; and an overcoat layer OC on a side of the plurality of first touch electrodes TE1 away from the touch insulating layer T1. Optionally, the display apparatus in the display area does not include the passivation layer PVX, e.g., the inter-layer dielectric layer ILD is in direct contact with the first planarization layer PLN1.

Referring to FIG. 18A and FIG. 18B, the display apparatus includes a semiconductor material layer SML, a first gate metal layer Gate1, a second gate metal layer Gate2, a first signal line layer SLL1, and a second signal line layer SLL2. The display apparatus further includes an insulating layer IN between the first gate metal layer Gate1 and the second gate metal layer Gate2; an inter-layer dielectric layer ILD between the second conductive layer Gate2 and the first signal line layer SLL1; and at least a passivation layer PVX or a planarization layer PLN between the first signal line layer SLL1 and the second signal line layer SLL2.

In another aspect, the present disclosure provides a method of fabricating a touch control structure. In some embodiments, the method includes forming a plurality of first touch electrodes, forming a plurality of second touch electrodes, forming a plurality of first touch control signal lines, and forming a plurality of second touch control signal lines. In some embodiments, the plurality of first touch control signal lines are formed to be connected to the plurality of first touch electrodes, respectively; the plurality of second touch control signal lines are formed to be connected to the plurality of second touch electrodes, respectively; multiple first touch electrodes of the plurality of first touch electrodes in a first region are formed to be connected to multiple first touch control signal lines of the plurality of first touch control signal lines on only a first side of a touch control region of the touch control structure; multiple first touch electrodes of the plurality of first touch electrodes in a second region are formed to be connected to multiple first touch control signal lines of the plurality of first touch control signal lines on a second side of a touch control region of the touch control structure; and the first side and the second side are different from each other

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously. many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A touch control structure, comprising a plurality of first touch electrodes, a plurality of second touch electrodes, a plurality of first touch control signal lines, and a plurality of second touch control signal lines;
wherein the plurality of first touch control signal lines are connected to the plurality of first touch electrodes, respectively;
the plurality of second touch control signal lines are connected to the plurality of second touch electrodes, respectively;
multiple first touch electrodes of the plurality of first touch electrodes in a first region are connected to multiple first touch control signal lines of the plurality of first touch control signal lines on only a first side of a touch control region of the touch control structure;
multiple first touch electrodes of the plurality of first touch electrodes in a second region are connected to multiple first touch control signal lines of the plurality of first touch control signal lines on a second side of a touch control region of the touch control structure; and
the first side and the second side are different from each other;
wherein the touch control structure comprises a window region;
wherein in a continuous row, all first touch blocks in the continuous row are electrically connected to each other;
in a respective non-continuous row of one or more non-continuous rows along the first direction, the window region spaces apart first touch blocks in the respective non-continuous row into a first part and a second part;
in a continuous column along a second direction, all second touch blocks in the continuous column are electrically connected to each other; and
in a respective non-continuous column of one or more non-continuous columns along the second direction, the window region spaces apart second touch blocks in the respective non-continuous column into a third part and a fourth part;
wherein the first region and the second region are non-overlapping regions; and
the window region is in the second region.

2. The touch control structure of claim 1, wherein multiple first touch electrodes of the plurality of first touch electrodes in a second region are connected to multiple first touch control signal lines of the plurality of first touch control signal lines on only a second side of a touch control region of the touch control structure.

3. The touch control structure of claim 2,
wherein first touch blocks in the first part in the respective non-continuous row are connected to a corresponding first touch control signal line of the plurality of first touch control signal lines; and
first touch blocks in the second part in the respective non-continuous row are electrically isolated from the corresponding first touch control signal line of the plurality of first touch control signal lines.

4. The touch control structure of claim 3, wherein one or more first touch blocks in the second part of the respective non-continuous row are electrically connected to first touch blocks in the continuous row; and
the one or more first touch blocks in the second part of the respective non-continuous row and the first touch blocks in the continuous row are configured to receive signals from and/or transmit signals to a same first touch control signal line of the plurality of first touch control signal lines.

5. The touch control structure of claim 3,
second touch blocks in the third part in the non-continuous column are connected to a corresponding second touch control signal line of the plurality of second touch control signal lines; and
second touch blocks in the fourth part in the respective non-continuous column are electrically isolated from the corresponding second touch control signal line of the plurality of second touch control signal lines.

6. The touch control structure of claim 5, wherein one or more second touch blocks in the fourth part of the respective non-continuous column are electrically connected to second touch blocks in the continuous column; and
the one or more second touch blocks in the fourth part of the respective non-continuous column and the second touch blocks in the continuous column are configured to receive signals from and/or transmit signals to a same second touch control signal line of the plurality of second touch control signal lines.

7. The touch control structure of claim 5, comprising a corner region;
wherein second parts of the one or more non-continuous rows and fourth parts of the one or more non-continuous columns are in the corner region;
the touch control structure outside the corner region is configured to detect a touch in a mutual-capacitance touch sensing mode;
the touch control structure in the first region is configured to detect a touch in a mutual-capacitance touch sensing mode; and
the touch control structure in the second region but outside the corner region is configured to detect a touch in a mutual-capacitance touch sensing mode.

8. The touch control structure of claim 7, wherein the corner region comprises a first self-capacitance touch region, a second self-capacitance touch region, and a mutual-capacitance region;
fourth parts of the one or more non-continuous columns are in the first self-capacitance touch region;
second parts of the one or more non-continuous rows are in the second self-capacitance touch region;
one or more first touch blocks in the mutual-capacitance region are electrically connected to one or more first touch control signal lines of the plurality of first touch control signal lines; and
one or more second touch blocks in the mutual-capacitance region are electrically connected to one or more second touch control signal lines of the plurality of second touch control signal lines.

9. The touch control structure of claim 7, wherein the corner region is part of the second region.

10. The touch control structure of claim 5, wherein all first touch blocks in second parts of the one or more non-continuous rows are electrically connected to first touch blocks in the continuous row;
all first touch blocks in second parts of the one or more non-continuous rows and the first touch blocks in the continuous row are configured to receive signals from and/or transmit signals to a same first touch control signal line of the plurality of first touch control signal lines;
all second touch blocks in fourth parts of the one or more non-continuous columns are electrically connected to second touch blocks in the continuous column; and
all second touch blocks in fourth parts of the one or more non-continuous columns and the second touch blocks in the continuous column are configured to receive signals from and/or transmit signals to a same second touch control signal line of the plurality of second touch control signal lines.

11. The touch control structure of claim 5, wherein every other row of first touch blocks in second parts of the one or more non-continuous rows are electrically connected to first touch blocks in the continuous row;
every other row of first touch blocks in second parts of the one or more non-continuous rows and the first touch blocks in the continuous row are configured to receive signals from and/or transmit signals to a same first touch control signal line of the plurality of first touch control signal lines;
every other column of second touch blocks in fourth parts of the one or more non-continuous columns are electrically connected to second touch blocks in the continuous column; and
every other column of second touch blocks in fourth parts of the one or more non-continuous columns and the second touch blocks in the continuous column are configured to receive signals from and/or transmit signals to a same second touch control signal line of the plurality of second touch control signal lines.

12. The touch control structure of claim 5, wherein every other row of first touch blocks in second parts of the one or more non-continuous rows are electrically connected to first touch blocks in the continuous row;
every other row of first touch blocks in second parts of the one or more non-continuous rows and the first touch blocks in the continuous row are configured to receive signals from and/or transmit signals to a same first touch control signal line of the plurality of first touch control signal lines;
all second touch blocks in fourth parts of the one or more non-continuous columns are electrically connected to second touch blocks in the continuous column; and
all second touch blocks in fourth parts of the one or more non-continuous columns and the second touch blocks in the continuous column are configured to receive signals from and/or transmit signals to a same second touch control signal line of the plurality of second touch control signal lines.

13. The touch control structure of claim 2, comprising a corner region;
the touch control structure outside the corner region is configured to detect a touch in a mutual-capacitance touch sensing mode;
the touch control structure in the first region is configured to detect a touch in a mutual-capacitance touch sensing mode; and
the touch control structure in the second region but outside the corner region is configured to detect a touch in a mutual-capacitance touch sensing mode.

14. The touch control structure of claim 2, comprising a corner region;
wherein the corner region comprises a first self-capacitance touch region, a second self-capacitance touch region, and a mutual-capacitance region;
one or more second touch blocks in the first self-capacitance touch region are electrically isolated from the plurality of second touch control signal lines;
one or more first second touch blocks in the first self-capacitance touch region are electrically connected to one or more first touch control signal lines of the plurality of first touch control signal lines;
one or more first touch blocks in the second self-capacitance touch region are electrically isolated from the plurality of first touch control signal lines;
one or more second touch blocks in the second self-capacitance touch region are electrically connected to one or more second touch control signal lines of the plurality of second touch control signal lines;
one or more first touch blocks in the mutual-capacitance region are electrically connected to one or more first touch control signal lines of the plurality of first touch control signal lines; and
one or more second touch blocks in the mutual-capacitance region are electrically connected to one or more second touch control signal lines of the plurality of second touch control signal lines.

15. The touch control structure of claim 1, wherein the second region comprising a first subregion and a second subregion;
multiple first touch electrodes of the plurality of first touch electrodes in the first subregion are connected to multiple first touch control signal lines of the plurality of first touch control signal lines on only the second side of a touch control region of the touch control structure; and
multiple first touch electrodes of the plurality of first touch electrodes in the second subregion are connected to multiple first touch control signal lines of the plurality of first touch control signal lines on the second side of a touch control region of the touch control structure, and connected to a plurality of third touch control signal lines on the first side of the touch control structure.

16. The touch control structure of claim 15, wherein the plurality of second touch electrodes are connected to the plurality of second touch control signal lines on a third side of a touch control region of the touch control structure;
multiple second touch electrodes of the plurality of first touch electrodes in a third subregion of the touch control region are connected to multiple second touch control signal lines of the plurality of second touch control signal lines on only the third side of the touch control region of the touch control structure;
multiple second touch electrodes of the plurality of first touch electrodes in a fourth subregion of the touch control region are connected to multiple second touch control signal lines of the plurality of second touch control signal lines on the third side of the touch control region of the touch control structure, and connected to a plurality of fourth touch control signal lines on a fourth side of the touch control region of the touch control structure; and
the third side and the fourth side are different from each other.

17. The touch control structure of claim 15, comprising a corner region;
wherein the touch control structure in the first region is configured to detect a touch in a mutual-capacitance touch sensing mode;
the touch control structure in the second region but outside the corner region is configured to detect a touch in a mutual-capacitance touch sensing mode; and
the touch control structure in the corner region is configured to detect a touch in a mutual-capacitance touch sensing mode.

18. The touch control structure of claim 15, wherein first touch blocks in the first part in the respective non-continuous row are connected to a corresponding first touch control signal line of the plurality of first touch control signal lines;
first touch blocks in the second part in the respective non-continuous row are electrically isolated from the corresponding first touch control signal line of the plurality of first touch control signal lines; and
first touch blocks in the second part in the respective non-continuous row are electrically connected to a corresponding third touch control signal line of the plurality of third touch control signal lines.

19. The touch control structure of claim 15, wherein second touch blocks in the third part in the non-continuous column are connected to a corresponding second touch control signal line of the plurality of second touch control signal lines;
second touch blocks in the fourth part in the respective non-continuous column are electrically isolated from the corresponding second touch control signal line of the plurality of second touch control signal lines; and
second touch blocks in the fourth part in the respective non-continuous column are electrically connected to a corresponding fourth touch control signal line of a plurality of fourth touch control signal lines.

20. A display apparatus, comprising the touch control structure of claim 1, and a display panel.
